(19) United States
(12) Patent Application Publication
(10) Pub. No.: US 2017/0023921 A1
(43) Pub. Date: Jan. 26, 2017

(54) METHOD OF CONTROLLING A REMOTE CONTROLLED SYSTEM

(71) Applicant: GRAND MATE CO., LTD., TAICHUNG CITY (TW)

(72) Inventors: CHUNG-CHIN HUANG, TAICHUNG CITY (TW); CHIN-YING HUANG, TAICHUNG CITY (TW); HSIN-MING HUANG, TAICHUNG CITY (TW); HSING-HSIUNG HUANG, TAICHUNG CITY (TW); YEN-JEN YEH, TAICHUNG CITY (TW); KUAN-CHOU LIN, TAICHUNG CITY (TW); YU-CHIN TSAI, TAICHUNG CITY (TW)

(73) Assignee: GRAND MATE CO., LTD., TAICHUNG CITY (TW)

(21) Appl. No.: 15/288,985

(22) Filed: Oct. 7, 2016

Related U.S. Application Data
(63) Continuation-in-part of application No. 14/527,362, filed on Oct. 29, 2014.

(30) Foreign Application Priority Data
Jul. 25, 2014 (CN) 201410359054.7

(51) Int. Cl. G05B 19/048; G05B 23/02

(52) U.S. Cl. CPC G05B 19/048; G05B 23/027; G05B 2219/2642; G05B 2219/31439

(57) ABSTRACT

A method of controlling a remote controlled system includes the steps: A. measuring a specific physical quantity with a detector; B. transmitting a signal to the relay apparatus; C. receiving the signal by the relay apparatus, and transmitting the detector ID code corresponding to the detector at the near end and the home appliance ID codes corresponding to the home appliances at the near end to the electronic device; D. obtaining an interactive link information by matching the corresponding relations in the database based on the received detector ID code and the received home appliance ID codes; E. sending the interactive link information to the relay apparatus; and F. transmitting a control command to the relevant home appliances base on the received interactive link information, whereby the relevant home appliances are controlled to perform a corresponding operation.

### RELATED APPLICATION

This application is a continuation in part of U.S. patent application: Ser. No. 14/527,362 titled “METHOD OF CONTROLLING A REMOTE CONTROLLED SYSTEM”, the subject matter thereof being fully incorporated herein by reference.

### BACKGROUND OF THE INVENTION

1. Technical Field

The present invention relates generally to controlling home appliances, and more particularly to a method of controlling a remote controlled system.

2. Description of Related Art

It is convenient to control home appliances with remote controls, since a user no longer has to go to where a home appliance is to control it. However, the number of remote controls seems to inevitably increase in any modern home, and it becomes a little annoying to find the right remote control among the others when needed. What makes things more complicated is that some remote controls even look alike, and therefore a user may find it inconvenient to distinguish the paring relations between each different home appliance and its corresponding remote control.

Hence, one kind of relay apparatus which can be communicated through wireless network is introduced to solve the problem. By using electronic devices such as tablet computers or smart phones, a user is able to transmit control commands to a relay apparatus, and the relay apparatus then converts the received control commands into corresponding control signals to be sent to specific home appliances. In this way, one electronic device is capable of controlling multiple home appliances, which effectively eases the trouble of dealing with too many remote controls.

However, the home appliances communicated with the same relay apparatus do not react to each other. For example, there can be a detector wirelessly connected to a relay apparatus to measure certain physical quantity and to check if the physical quantity goes abnormal, and such a relay apparatus can merely transmit the readings of its detector to an electronic device for display, which means the abnormal situation cannot be feedbacked to other home appliances for proceeding any corresponding operations. For another example, some home appliances are provided with detectors, and the physical quantities measured by these detectors can be only used by the belonging home appliances; the information cannot be feedbacked to others. In fact, some appliances are controlled based on the same physical quantity, and in light of this, the conventional design may cause unnecessary cost.

### BRIEF SUMMARY OF THE INVENTION

In view of the above, the primary objective of the present invention is to provide a method of controlling a remote controlled system, which feedbacks readings of detectors to other home appliances.

The present invention provides a method of controlling a remote controlled system, wherein the remote controlled system includes a relay apparatus, at least one detector, a plurality of home appliances, and an electronic device. The relay apparatus, the at least one detector, and the plurality of home appliances are provided at a near end. The relay apparatus communicates with the detector and the home appliances wirelessly. The electronic device communicates with the relay apparatus wirelessly, and has a database having corresponding relations between a plurality of detector ID codes and a plurality of home appliance ID codes, wherein each of the plurality of detector ID codes corresponds to one of various types of detectors, and each of the plurality of home appliance ID codes corresponds to one of various types of home appliances. For each of the at least one detector at the near end, there is one of the detector ID codes in the database corresponding thereto; for each of the home appliances at the near end, there is one of the home appliance ID codes in the database corresponding thereto. The method of controlling the remote controlled system includes the steps of:

A. measuring a specific physical quantity with the at least one detector;

B. transmitting a signal corresponding to the specific physical quantity to the relay apparatus;

C. receiving the signal by the relay apparatus, and transmitting the detector ID code corresponding to the at least one detector at the near end and the home appliance ID codes corresponding to the home appliances at the near end to the electronic device;

D. receiving the transmitted detector ID code and the transmitted home appliance ID codes by the electronic device, and obtaining an interactive link information by matching the corresponding relations in the database based on the received detector ID code and the received home appliance ID codes, wherein the interactive link information includes the corresponding relation between the received detector ID code and the home appliance ID codes corresponding to at least part of the home appliances at the near end;

E. sending the interactive link information to the relay apparatus;

F. receiving the interactive link information by the relay apparatus, and transmitting a control command to the relevant home appliances base on the received interactive link information, whereby the relevant home appliances are controlled to perform a corresponding operation.

With the method provided in the present invention, according to the physical quantity measured by the detectors, the information can be feedbacked to the corresponding home appliances. The method requires fewer detectors than the conventional way of controlling home appliances.

### BRIEF DESCRIPTION OF THE SEVERAL VIEWS OF THE DRAWINGS

The present invention will be best understood by referring to the following detailed description of some illustrative embodiments in conjunction with the accompanying drawing, in which

FIG. 1 is a schematic diagram showing the remote controlled system of a first preferred embodiment of the present invention;

FIG. 2 is a flow chart of the first preferred embodiment, showing the method of controlling the remote controlled system;

FIG. 3 is a flow chart of a second preferred embodiment, showing the method of controlling the remote controlled system; and

FIG. 4 is a flow chart of a third preferred embodiment, showing the method of controlling the remote controlled system.

### DETAILED DESCRIPTION OF THE INVENTION

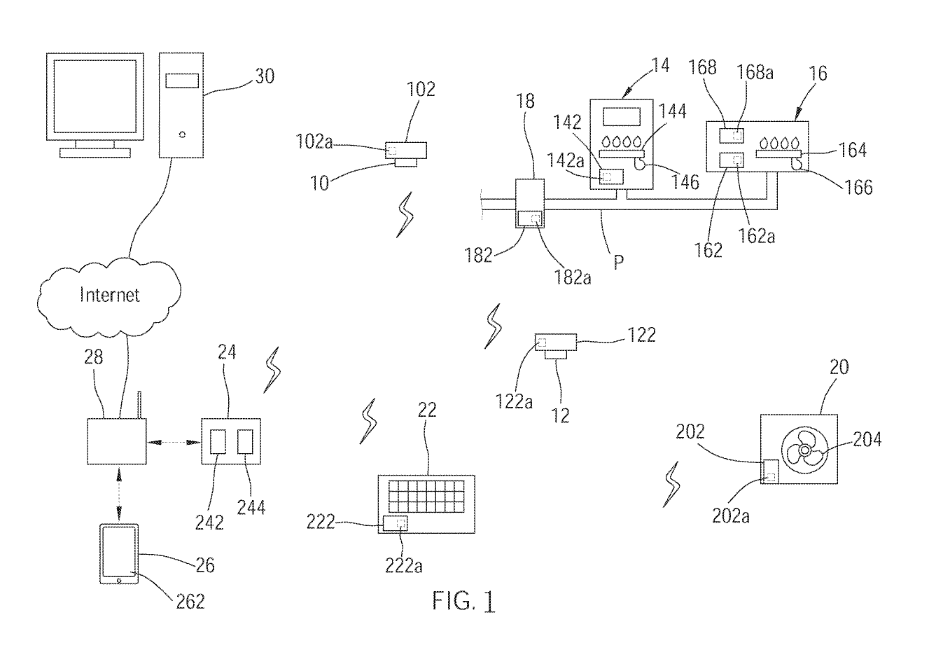

As shown in FIG. 1, a remote controlled system, which is applied with the method of controlling a remote controlled system of the first preferred embodiment of the present invention, includes a plurality of detectors (a carbon monoxide detector 10 and a smoke detector 12 in the preferred embodiment), a plurality of home appliances (a water heater 14, a fireplace 16, a gas valve 18, a ventilation device 20, and an air conditioner 22 in the preferred embodiment), a relay apparatus 24, an electronic device which is a tablet computer 26 as an example, and another electronic device which is a server 30 at a far end (outside a near end) as an example. The detectors, the home appliances, and the relay apparatus 24 are installed at the near end.

Each detector is respectively used to detect a specific physical quantity. Specifically, the physical quantity detected by the carbon monoxide detector 10 is the concentration of carbon monoxide, while the physical quantity detected by the smoke detector 12 is the concentration of smoke particles.

The carbon monoxide detector 10 and the smoke detector 12 are respectively electrically connected to a control device 102, 122. Each of the control devices 102, 122 has a wireless signal transmission circuit 102a, 122a, which communicates to the relay apparatus 24 with signals. Each of the control device 102, 122 respectively stores an ID code corresponding to the belonging detector 10, 12.

In addition, the control device 102 connected to the carbon monoxide detector 10 stores an abnormal value and an indicative value which is lower than the abnormal value, wherein the concentration of carbon monoxide higher than the abnormal value is high enough to cause immediate harm, and if the concentration of carbon monoxide exceeds the indicative value yet not reaches the abnormal value, it is not really harmful but still not good for anyone to stay in such circumstance for too long. Once the control device 102 finds out that the concentration of carbon monoxide measured by the detector 10 exceeds the abnormal value, it sends out an abnormal signal to the relay apparatus 24 through the wireless signal transmission circuit 102a; if the control device 102 determines that the concentration of carbon monoxide measured by the carbon monoxide detector 10 is between the indicative value and the abnormal value, it sends out a warning signal to the relay apparatus 24. Furthermore, if the control device 102 finds out that the concentration of carbon monoxide stays between the abnormal value and the indicative value for a certain period of time, it also sends out the abnormal signal for safety reasons.

Similarly, the control device 122 connected to the smoke detector 12 also stores an indicative value and an abnormal value for the concentration of smoke particles, wherein the concentration of smoke particles higher than the abnormal value means a fire hazard is taking place. If the control device 122 finds out that the concentration of smoke particles detected by the detector 12 exceeds the abnormal value, it sends out an abnormal signal to the relay apparatus 24 through the wireless signal transmission circuit 122a.

In the preferred embodiment, the home appliances 14, 16, 18, 20, 22 can be classified into two types, which are gas appliances and electric equipment. More specifically, the water heater 14, the fireplace 16, and the gas valve 18 belong to the type of gas appliances, while the ventilation device 20 and the air conditioner 22 belong to the type of electric equipment. Each of the home appliances 14, 16, 18, 20, 22 includes a control device 142, 162, 182, 202, 222 to control the operations thereof; each of the control devices 142, 162, 182, 202, 222 has a wireless signal receiving circuit 142a, 162a, 182a, 202a, 222a to receive control commands, and the control device 142, 162, 182, 202, 222 of each of the home appliances 14, 16, 18, 20, 22 controls the home appliances 14, 16, 18, 20, 22 to perform operations correspondingly. The home appliances 14, 16, 18, 20, 22 perform a specific operation after receiving an abnormal control command, which will be described in details later. Each of the control devices 142, 162, 182, 202, 222 stores an ID code corresponding to the belonging home appliance 14, 16, 18, 20, 22.

In the preferred embodiment, the water heater 14 and the fireplace 16 are installed indoors, and they are communicated to a same gas pipe P. The water heater 14 includes a burner 144 and a blower 146 connected to the burner 144, wherein the burner 144 burns gas, and the blower 146 can be controlled by the control device 142 to change its rotational speed to regulate the air amount flowing into the burner 144 for combustion. The water heater 14 further includes an exhaust pipe (not shown) to vent the exhaust gas generated due to burning gas.

In addition to a burner 164, a blower 166, and an exhaust pipe (not shown), the fireplace 16 further includes an oxygen depletion sensor (ODS) 168, which has an oxygen concentration detector 168a, and the physical quantity measured by the oxygen concentration detector 168a is the oxygen concentration while the fireplace 16 is burning gas. The control device 162 of the fireplace 16 also stores an abnormal value and an indicative value which is higher than the indicative value. Similarly, if the control device 162 finds out that the oxygen concentration measured by the oxygen concentration detector 168a is lower than the abnormal value, it sends out an abnormal signal to the relay apparatus 24 through the wireless signal transmission circuit 162a; if the control device 162 determines that the oxygen concentration is between the indicative value and the abnormal value, it sends out a warning signal. Since the oxygen concentration detector 168a is one kind of detectors, the control device 162 also stores an ID code corresponding to the oxygen concentration detector 168a.

The gas valve 18 is installed at a source of the gas pipe P, wherein the control device 182 controls a valve (not shown) of the gas valve 18 to open or close the gas pipe P.

The ventilation device 20 is installed at a vent of a building, wherein the ventilation device 20 includes an exhaust fan 204, and the control device 202 thereof controls the exhaust fan 204 to operate to provide indoor and outdoor air exchange. The control device 222 controls the operation of the air conditioner 22 to adjust room temperature.

The relay apparatus 24 has a memory 242 and a wireless transceiver circuit 244, wherein the memory 242 stores interactive link information, which designates corresponding interactions between each of the detectors and at least one of the home appliances. The wireless transceiver circuit 244 communicates with the control devices 102, 122, 142, 162, 182, 202, 222.

The tablet computer 26 communicates with the relay apparatus 24 with WiFi signals through an access point (AP) 28, wherein the tablet computer 26 can be used to control the home appliances through the relay apparatus 24. The tablet computer 26 has an alarm unit which is a screen 262 as an example.

The server 30 communicates with the AP 28 through Internet to communicate with the relay apparatus 24. The server 30 is provided by a manufacturer of the remote controlled system, wherein the server 30 has a database, which stores the ID codes corresponding to a plurality of detectors available from the manufacturer and a plurality of home appliances. In other words, the database stores information about the corresponding relation between the ID codes and the detectors or the home appliances. For each of the at least one detector at the near end, there is one of the detector ID codes in the database corresponding thereto; for each of the home appliances at the near end, there is one of the home appliance ID codes in the database corresponding thereto.

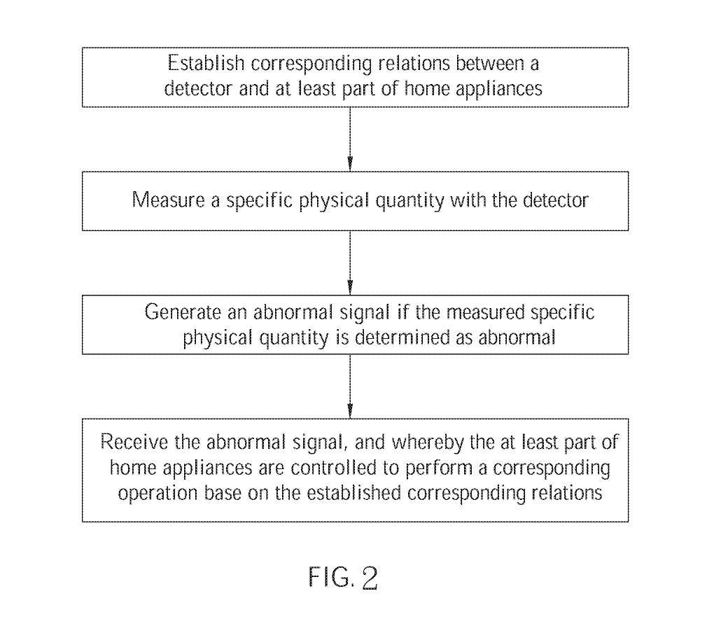

The first preferred embodiment of the method provided in the present invention is shown in FIG. 2, and includes the following steps:

First, the relay apparatus 24 transmits the ID codes corresponding to the detectors and the home appliances at the near end to the server 30, and the server 30 determines what interactions are possible between the detectors at the near end and the home appliances available from the manufacturer based on the information stored in the database. The ID codes of the home appliances and the detectors at the near end which are able to take interactions are recorded in this way, and therefore the corresponding relations between the detectors and the home appliances at the near end are established and noted. Such information is then transmitted back to the relay apparatus 24 and to be stored in the memory 242. The herein stored information is the aforementioned interactive link information.

For example, the interactive link information stored in the memory 242 of the relay apparatus 24 includes the corresponding relations between the carbon monoxide detector 10 and the water heater 14, the fireplace 16, and the ventilation device 20. Furthermore, corresponding relation between the oxygen concentration detector 162a of the fireplace 16 and the ventilation device 20, the corresponding relations between the smoke detector 12 and the water heater 14, the fireplace 16, the gas valve 18, and the air conditioner 22 are also included in the interactive link information.

If the control device 102 connected to the carbon monoxide detector 10 finds out that the concentration of carbon monoxide measured by the carbon monoxide detector 10 reaches the indicative value, it sends out the warning signal to the relay apparatus 24, and then the relay apparatus 24 transmits the warning signal to the tablet computer 26. In this way, the screen 262 can display a warning message to inform the user that the concentration of carbon monoxide is abnormally high. If the concentration of carbon monoxide stays between the abnormal value and the indicative value for a certain period of time, or if the concentration of carbon monoxide reaches the abnormal value, the control device 102 sends out the abnormal signal. After receiving the abnormal signal, according to the interactive link information stored in the memory 242, the relay apparatus 24 transmits the abnormal control command to the corresponding home appliances, namely, the water heater 14, the fireplace 16, and the ventilation device 20. Consequently, the blowers 144, 146 of the water heater 14 and the fireplace 16 are controlled to change their rotational speed, which makes the ratio of the amount of combustion-supporting air to the amount of gas appropriate for reducing carbon monoxide generated by burning gas, and the exhaust fan 204 is also switched on to exhaust the carbon monoxide out more effectively for safety reasons. At the same time, the relay apparatus 24 also transmits the warning signal to the tablet computer 26 for displaying, and the user can be informed that the concentration of carbon monoxide is high enough to be harmful.

Similarly, if the control device 162 of the fireplace 16 finds out that the oxygen concentration measured by the oxygen concentration detector 168a is lower than the indicative value, it sends out the warning signal to be displayed on the tablet computer 26 through the relay apparatus 24. If the oxygen concentration is between the abnormal value and the indicative value, or if it reaches the abnormal value, the abnormal signal is sent out, and the relay apparatus 24 transmits the abnormal control command to the ventilation device 20 based on the interactive link information, which switches on the exhaust fan 204 to create indoor and outdoor air exchange to increase the indoor oxygen concentration. Again, the relay apparatus 24 also transmits the warning signal to the tablet computer 26 for displaying, and the user can be informed that the oxygen concentration is abnormal.

If the control device 122 connected to the smoke detector 12 finds out that the concentration of smoke particles is higher than the abnormal value, it means there is a fire hazard taking place, and the abnormal signal is sent to the relay apparatus 24. After that, the relay apparatus 24 transmits the abnormal control command to the water heater 14, the fireplace 16, the gas valve 18, and the air conditioner 22 according to the interactive link information, which makes the water heater 14, the fireplace 16, the gas valve 18, and the air conditioner 22 stop operating, and the gas valve 18 is also controlled to close the gas pipe P.

In summary, the method of controlling a remote controlled system provided in the present invention takes the physical quantities measured by common detectors as a basis of controlling home appliances. In light of this, the method requires fewer detectors than the conventional way.

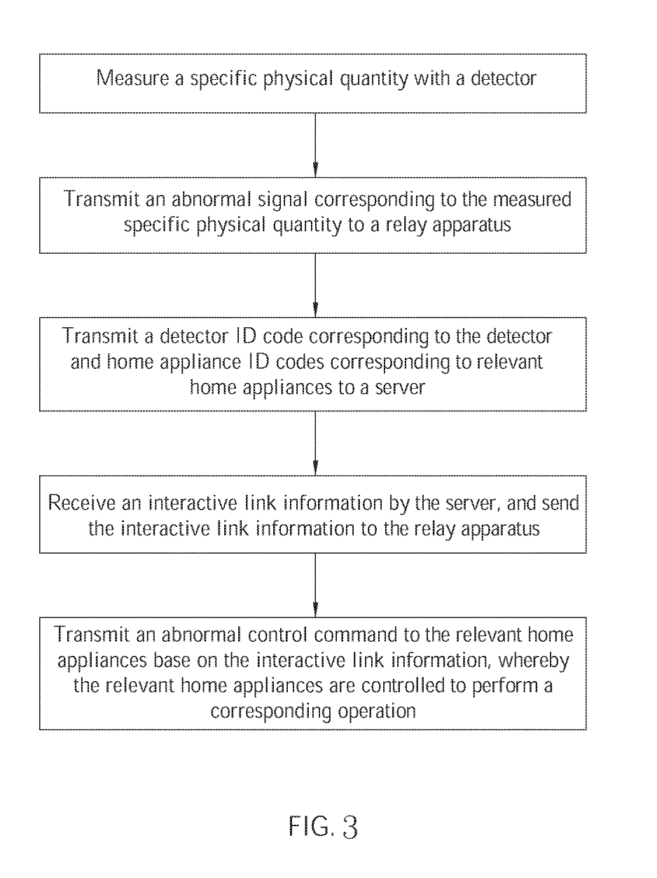

The second preferred embodiment of the method provided in the present invention is shown in FIG. 3, and includes the following steps which are similar to that of the first preferred embodiment.

The detectors in the embodiment includes a carbon monoxide detector 10. If the specific physical quantity measured by the carbon monoxide detector 10 reaches the abnormal value, the control device 102 transmits an abnormal signal to the relay apparatus 24.

After receiving the abnormal signal, the relay apparatus 24 transmits the detector ID code of the carbon monoxide detector 10 and the corresponding home appliance ID codes to the server 30.

The server 30 obtains an interactive link information by matching the corresponding relations in the database based on the received detector ID code and the received home appliance ID codes, and sends the interactive link information to the relay apparatus 24. The interactive link information includes the corresponding relation between the received carbon monoxide detector ID code and the home appliance ID codes corresponding to at least part of the home appliances at the near end.

After receiving the interactive link information, the relay apparatus 24 transmits an abnormal control command to the relevant home appliances base on the received interactive link information, whereby the relevant home appliances are controlled to perform a corresponding operation. For example, the abnormal control command is transmitted to the heater 14, the fireplace 16, and the ventilation device 20, to control the blowers 146, 166 of the heater 14 and the fireplace 16 to accelerate the rotational speed, and to control the exhaust fan 204 to operate.

Practically, the interactive link information transmitted from the server 30 can be stored in the memory 242 of the relay apparatus 24. Afterwards, if the specific physical quantity measured by the carbon monoxide detector 10 reaches the abnormal value, the relay apparatus 24 transmits the abnormal signal to the relevant home appliances base on the stored interactive link information, whereby the relevant home appliances are controlled to perform the corresponding operation. In another embodiment, the interactive link information is stored in a tablet computer 40, and the tablet computer 40 performs what the server 30 performs in the steps of the second embodiment.

The detector in the second preferred embodiment could be a smoke detector 12, or one of the detectors installed in the home appliances at the near end, e.g., the oxygen concentration detector 168a of the fireplace 16. If the control device 162 of the fireplace 16 determines that the oxygen concentration measured by the oxygen concentration detector 168a is abnormal, the control device 162 transmits the abnormal signal to the relay apparatus 24.

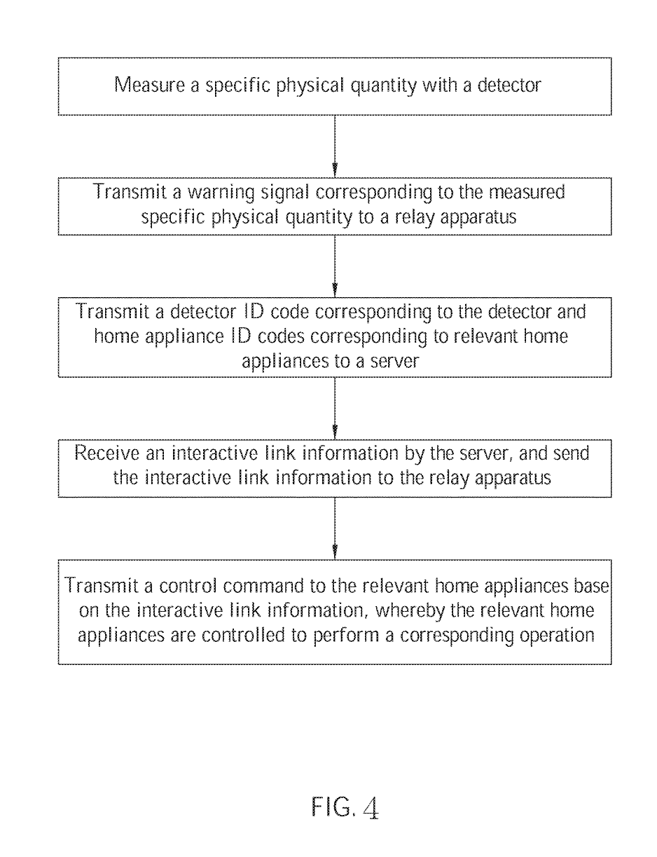

The third preferred embodiment of the method provided in the present invention is shown in FIG. 4, and includes the following steps which are similar to that of the second preferred embodiment.

If the specific physical quantity measured by the carbon monoxide detector 10 reaches the indicative value, the control device 102 transmits a warning signal to the relay apparatus 24. After receiving the warning signal, the relay apparatus 24 transmits the detector ID code of the carbon monoxide detector 10 and the corresponding home appliance ID codes to the server 30. Afterwards, the server 30 obtains the interactive link information, and sends the interactive link information to the relay apparatus 24.

After the relay apparatus 24 receives the interactive link information, the received interactive link information stores in the memory 242 of the apparatus 24. Subsequently, the relay apparatus 24 transmits a control command to the relevant home appliances base on the received interactive link information, whereby the relevant home appliances are controlled to perform a corresponding operation, e. g., the exhaust fan 204 is controlled to operate.

If the specific physical quantity measured by the carbon monoxide detector 10 reaches the abnormal value, the abnormal signal is transmitted to the relay apparatus 24. After receiving the abnormal signal, the relay apparatus 24 transmits an abnormal control command to the relevant home appliances base on the received interactive link information, whereby the relevant home appliances are controlled to perform a corresponding operation, wherein said relevant home appliances are different from the home appliances which perform corresponding operation if the specific physical quantity reaches the indicative value, e. g., the heater 14 and the fireplace 16 are controlled to stop burning gas.

In another embodiment, the interactive link information is stored in the tablet computer 40, and the tablet computer 40 performs what the server 30 performs in the steps of the third embodiment.

It must be pointed out that the embodiment described above is only a preferred embodiment of the present invention. All equivalent methods which employ the concepts disclosed in this specification and the appended claims should fall within the scope of the present invention.

What is claimed is:

1. A method of controlling a remote controlled system, wherein the remote controlled system includes a relay apparatus, at least one detector, a plurality of home appliances, and an electronic device; the relay apparatus, the at least one detector, and the plurality of home appliances are provided at a near end, wherein the relay apparatus communicates with the detector and the home appliances wirelessly; the electronic device communicates with the relay apparatus wirelessly, and has a database having corresponding relations between a plurality of detector ID codes and a plurality of home appliance ID codes, wherein each of the plurality of detector ID codes corresponds to one of various types of detectors, and each of the plurality of home appliance ID codes corresponds to one of various types of home appliances; for each of the at least one detector at the near end, there is one of the detector ID codes in the database corresponding thereto; for each of the home appliances at the near end, there is one of the home appliance ID codes in the database corresponding thereto; comprising the steps of:
A. measuring a specific physical quantity with the at least one detector;
B. transmitting a signal corresponding to the specific physical quantity to the relay apparatus;
C. receiving the signal by the relay apparatus, and transmitting the detector ID code corresponding to the at least one detector at the near end and the home appliance ID codes corresponding to the home appliances at the near end to the electronic device;
D. receiving the transmitted detector ID code and the transmitted home appliance ID codes by the electronic device, and obtaining an interactive link information by matching the corresponding relations in the database based on the received detector ID code and the received home appliance ID codes, wherein the interactive link information comprises the corresponding relation between the received detector ID code and the home appliance ID codes corresponding to at least part of the home appliances at the near end;
E. sending the interactive link information to the relay apparatus;
F. receiving the interactive link information by the relay apparatus, and transmitting a control command to the relevant home appliances base on the received interactive link information, whereby the relevant home appliances are controlled to perform a corresponding operation.

2. The method of claim 1, wherein step F further comprises storing the interactive link information sent by the electronic device in the relay apparatus; the method further comprises the following steps after step F:
measuring another physical quantity with the at least one detector;
transmitting another signal corresponding to the another physical quantity to the relay apparatus;
transmitting another control command to the relevant home appliances base on the interactive link information stored in the relay apparatus, whereby the relevant home appliances are controlled to perform another corresponding operation.

3. The method of claim 1, wherein step B further comprises determining whether the measured specific physical quantity is abnormal, wherein the signal corresponding to the specific physical quantity is transmitted to the relay apparatus if the specific physical quantity is abnormal; the signal is an abnormal signal; the control command is an abnormal control command.

4. The method of claim 3, wherein one of the home appliances at the near end includes the at least one detector, which measures the specific physical quantity while said home appliance is operating.

5. The method of claim 4, wherein one of the home appliances which includes the at least one detector is a gas appliance, and the at least one detector is an oxygen concentration detector, which is adapted to measure oxygen concentration while the gas appliance is burning gas, wherein the specific physical quantity is the oxygen concentration; one of the at least part of the home appliances at the near end mentioned in step D includes an exhaust fan; the home appliance which includes the exhaust fan is controlled in step F to switch on the exhaust fan.

6. The method of claim 3, further comprising the step of predetermining an indicative value and an abnormal value, wherein before reaching the abnormal value, the specific physical quantity reaches the indicative value first; if the measured specific physical quantity reaches the indicative value, a warning signal is generated to be received by the relay apparatus, which then transmits the warning signal to an alarm unit for alarming; if the measured specific physical quantity reaches the abnormal value, the specific physical quantity is determined as abnormal, and the abnormal signal is generated.

7. The method of claim 1, further comprising the step of predetermining an indicative value and an abnormal value, wherein before reaching the abnormal value, the physical quantity reaches the indicative value first; in step B, the signal is transmitted to the relay apparatus if the measured specific physical quantity reaches the indicative value, wherein the signal is a warning signal; the method further comprises the following steps after step F:
generating an abnormal signal if the measured specific physical quantity reaches the abnormal value;
transmitting an abnormal control command to the relevant home appliances base on the interactive link information, whereby said relevant home appliances are controlled to perform another corresponding operation, wherein the home appliances controlled in the current step are different from the home appliances controlled in step F.

8. The method of claim 3, further comprising the step of predetermining an indicative value and an abnormal value, wherein before reaching the abnormal value, the specific physical quantity reaches the indicative value first; if the measured specific physical quantity reaches the abnormal value or stays between the indicative value and the abnormal value for a certain period of time, the measured specific physical quantity is determined as abnormal, and the abnormal signal is generated.

9. The method of claim 3, wherein the at least one detector comprises a carbon monoxide detector, and the specific physical quantity is concentration of carbon monoxide; one of the at least part of the home appliances at the near end in step D is a gas appliance, which includes a burner and a blower; said gas appliance is controlled in step F to change a rotational speed of the blower.

10. The method of claim 9, further comprising the step of predetermining an indicative value and an abnormal value, wherein before reaching the abnormal value, the concentration of carbon monoxide reaches the indicative value first; if the measured concentration of carbon monoxide reaches the abnormal value, or stays between the indicative value and the abnormal value for a certain period of time, the measured concentration of carbon monoxide is determined as abnormal, and the abnormal signal is generated.

11. The method of claim 3, wherein the at least one detector comprises a smoke detector, and the specific physical quantity is concentration of smoke particles; the at least part of the home appliances at the near end in step D include a gas appliance and a gas valve, wherein the gas appliance communicates with a gas pipe, and the gas valve is installed on the gas pipe; the gas appliance is controlled in step F to stop operating, and to close the gas pipe through the gas valve.
